(19) United States
(12) Patent Application Publication
(10) Pub. No.: US 2005/0015754 A1
(43) Pub. Date: Jan. 20, 2005

(54) METHOD AND SYSTEM FOR MULTIMODE SIMULATOR GENERATION FROM AN INSTRUCTION SET ARCHITECTURE SPECIFICATION

(75) Inventors: Bengt Werner, Akersberga (SE); Magnus Christensson, Stockholm (SE); Fredrik Larsson, Solna (SE)

Correspondence Address: ALBIHNS STOCKHOLM AB, BOX 5581, Linnegatan 2, SE-114 85 STOCKHOLM; Sweden, STOCKHOLM, SE

(73) Assignee: VIRTUTECH AB, Stockholm (SE)

(21) Appl. No.: 10/710,099

(22) Filed: Jun. 18, 2004

Related U.S. Application Data
(60) Provisional application No. 60/320,281, filed on Jun. 18, 2003.

(51) Int. Cl. G06F 9/45

(52) U.S. Cl. 717/136; 717/138

(57) ABSTRACT

The present invention discloses method and system for a multimode simulator having an emulation core with improved performance. In an embodiment of the invention, the overhead caused by the exclusive use of the simulation technique using one instruction-at-a-time interpretation is reduced by additionally using binary translation for executed blocks of interpreted instructions (i.e. that contain no jumps out of the block) from the same instruction set architecture description. Since performing translations too frequently can undesirably increase overhead by overloading the cache, the binary translation is only performed for blocks that are executed frequently. Once the blocks are translated e.g. by forming the block from instructions via templates and generating the collective code, the overall simulator performance is significantly improved by running the blocks instead of running the instructions one-at-a-time.

### CROSS REFERENCE To RELATED APPLICATIONS

This application claims the benefit of a U.S. Provisional Application No. 60/320,281 filed on Jun. 18, 2003.

### BACKGROUND OF INVENTION

### FIELD OF INVENTION

The present invention relates generally to software based computer system simulators and, more particularly, to a multimode simulation technique that improves simulator performance by using multiple translation modes for generating the simulated instruction code.

A full system simulator is generally a collection of modules that are used to simulate computer systems. Such a simulator has a broad spectrum of uses, ranging from hardware emulation to computer architecture research. Software engineers use the simulator as an emulator when hardware is either scarce or not available at all. In such a role, the speed of the simulator is of paramount importance. The most time critical component in an instruction set simulator is the emulation core, which performs the same function as the CPUs would in an actual computer system.

Emulation systems differ mainly by the extent caching and analysis of the emulated target code is performed. On one end of the spectrum, there are relatively simple fetch-decode-emulate loop emulators that do not cache anything not strictly related to the emulated processor's architectural state. On the other end of the spectrum, there are static binary translators that translate the entire program from the target architecture to the host platform, often using sophisticated whole program analysis. A more detailed description can be found in the article (REF1) entitled “Binary Translation” by Richard L. Sites and Anton Chernoff and Matthew B. Kerk and Maurice P. Marks and Scott G. Robinson, Communications of the ACM, vol. 36, p. 69-81, February 1993.

In some simulators the traditional core of the simulator uses a one-instruction-at-a-time type of emulation. Each instruction is decoded once to an intermediate representation which is then interpreted each time that the particular target instruction is run. However, there are two major performance bottlenecks that affect this type of emulation. The first bottleneck is the branch miss-prediction overhead in the main emulation loop, which is often higher than desirable because of indirect jumps that are difficult to predict. The second bottleneck is the high pressure placed on the data cache due to the relatively sparse intermediate code. This is because the intermediate code can be bigger and more sparse (meaning that the cache will be poorly utilized) than the corresponding instructions that should be simulated. The intermediate code is also stored as data, as opposed to real code that is executed on a host, which means that the intermediate code will be stored in the data cache, unlike the real code that will be stored in the instruction cache. Thus the intermediate code tends to put more pressure on the data cache than the real code.

In view of the foregoing, it is desirable to provide a commercial quality level simulation platform that offers improved simulator performance in order to more accurately model workloads by running unmodified code in realistic configurations.

### SUMMARY OF INVENTION

Briefly described and in accordance with embodiments and related features of the invention, there is provided a method and system for providing a multimode simulator having an emulation core with improved performance. In an embodiment of the invention, the overhead caused by the exclusive use of the simulation technique using one instruction-at-a-time interpretation is reduced by additionally using of binary translation for executed blocks of interpreted instructions generated from the same instruction set architecture description. Since performing translations too frequently can undesirably increase overhead by overloading the cache, the binary translation is only performed for blocks that are executed very frequently. Once the blocks are translated by forming the block from instructions via templates, the overall simulator performance is significantly improved by running the blocks instead of running the instructions one-at-a-time.

In accordance with another aspect of the invention, a computer program product capable of being run on a host system for simulating in software a digital computer system comprising a computer readable storage medium having a computer readable program code means embedded in the medium. The computer readable program code means comprises computer instruction means for performing simulation in software of a digital computer system. The simulation performance is improved by using a multimode simulation process that includes computer instruction means for providing dynamic single instruction interpretation and binary translation for suitable blocks of instructions that are generated from the same instruction set architecture description. The simulator is able to provide the exact same output result regardless of whether or to what extent either the single instruction interpretation or the binary translation process is performed.

### BRIEF DESCRIPTION OF DRAWINGS

The invention, together with further objectives and advantages thereof, may best be understood by reference to the following description taken in conjunction with the accompanying drawings in which:

FIG. 1 is a flowchart of multimode simulation technique operating in accordance with an embodiment of the invention.

### DETAILED DESCRIPTION

In accordance with an embodiment of the invention, an improved method is described for use in a full system simulator to speed up the simulator's emulation core. The method augments an existing interpreter with dynamic code generation, accelerating commonly emulated blocks of instructions. However, the inventive technique comprises a mechanism for building a code generator from the same instruction set architecture description that is used to generate an interpreter.

In simulators using a traditional core of the one-instruction-at-a-time emulation the performance limiting bottlenecks can be substantially reduced by translating larger blocks of instructions, and by chaining them together, thereby avoiding the indirection in the main emulation loop. By indirection it is meant e.g. that a jump to a location in the simulator code is determined when the simulator program is run, as opposed to when the simulator program is compiled. By way of example, a jump to the address stored in register x is an indirect jump, as opposed to a direct jump to the specific location 4096. The value of x will be determined when the program is run, whereby the specific location 4096 is determined when you compile the program. Modern processors will tend to execute the last case faster than the first case, therefore chaining blocks together will allow one to convert the first case to the second case thereby obtaining performance improvements.

Both dynamic translation, and the method of chaining blocks together are methods that have been used in research simulation systems. However, the present invention describes a method of deriving large parts of the code generator from an existing description of the target architecture, expressed in a high level language.

In accordance with the embodiment, the instruction set architecture used in, for example, the Simics™simulation system from Virtutech AB of Stockholm, Sweden, is described in a special purpose language from which an exemplary Simgen tool generates the main parts of the decoder and the interpreter core. The Simgen tool is a tool that takes the specification in the special purpose language describing the architecture to simulate and generate parts of the simulator. The present invention adds to this by passing the output from the Simgen tool through another compilation step, generating a data structure for each decode leaf instruction. A decode leaf can be, for example, an instruction type or a specialized subset of an instruction type as selected either by hand or automatically from opcode statistics feedback. The resulting data structure, called the instruction template, is a collection of operations in an exemplary language such the Turbo1 language. An advantage with having specialized templates is that it relieves pressure from the runtime optimizer, however, it adds to the memory footprint since more templates are needed to cover the instruction set.

By way of example, the following is an exemplary Simgen description for the ADD instruction in the SPARC-V9 instruction set, which adds a register to either another register or to an immediate value encoded in the instruction.

```
instruction ADD({RS1}, {REG_OR_IMM_RSVD}, {DST})
pattern
  op == %10 && op3 == %000000
  syntax
  “ADD {RS1}, {REG_OR_IMM_RSVD}, {DST}”
  semantics
  #{SET({DST}, {RS1}+{REG_OR_IMM_RSVD}); #}
```

For this instruction, the Simgen tool will generate the following service routine for the specialized case where the second operand is a register:

```
template
sparc_turbo_ep_ADD(unsigned int rs2, unsigned int rs1, unsigned int rd)
{
  prologue( );
  do {
    ireg_t _dest = REG_R(rs1) + REG_R(rs2);
    REG_TURBO_W(_dest, rd);
  } while(0);
  epilogue( );
}
```

The parameters are determined when the instruction is decoded. In this case the parameters are the numbers of the registers used as source and destination operands. The service routine output by Simgen is then compiled into Turbo1, resulting in the following instruction template (where comments are shown to the right):

sparc_turbo_ep_ADD (u32 rs2, u32 rs1, u32 rd)

| | |
|---|---|
| ( | |
| prologue( ) | // Instruction barrier |
| iop_0x401aab80: | |
| field(u32_100, rs1) | // Get first source register number |
| REG_R(u64_101, u32_100) | // Read first source register |
| field(u32_102, rs2) | // Get second source register number |
| REG_R(u64_103, u32_102) | // Read second source register |
| add(u64_104, u64_101, | // 64-bit addition |
| u64_103) | |
| copy(u64_106, u64_104) | // Copy to expression destination |
| conv_u64_to_u64(u64_105, | // Assign to_dest |
| u64_106) | |
| field(u32_107, rd) | // Get destination register number |
| REG_TURBO_W(u64_105, | // Write value to destination |
| u32_107) | |
| const_s32(s32_108, 0) | // do-while condition |
| j_nz(iop_0x401aab80, s32_108) | // Branch to top of loop |
| | if condition true |
| epilogue( ) | // Fall-through to next instruction |
| ) | |

As can be seen in the template for the ADD instruction, the exemplary Turbo1 language has typed basic operations, such as adds and shifts, and also has target specific operations such as simulated register reads and writes. The target specific operations are used for operations that cannot easily be expressed using the standard target independent operations. Where the boundary is drawn between implementing functionality directly in the specification language and having the feature mapped to a target specific macro-operation can be changed depending on the performance requirements of the code generator. The benefit of having target specific macros is mainly that it can result in code that is generated in a smaller and/or faster way, however, the downside is that such macros have to be written for all host architectures.

The fact that a working interpreter exists is utilized to reduce the additional work needed to implement a code generating version. Infrequent or arcane instructions are therefore omitted from the translation mechanism, which is handled by adding an attribute to the instruction set architecture description. The example below shows where the MULSCC instruction (in the SPARC-V9 instruction set) is marked as not handled by the code generator:

```
instruction MULScc({RS1}, {REG_OR_IMM_RSVD}, {DST})
pattern
  op == %10 && op3 == %100100
  syntax
  “mulscc {RS1}, {REG_OR_IMM_RSVD}, {DST}”
  semantics
  #{
  uint32 operand1, operand2, tmp;
  uint64 result;
  ccodes_t new_cc;
  new_cc.flags = 0;
  operand1 = (get_icc_n_current() \hat{ }get_icc_v_current()) << 31;
  tmp = {RS1};
  operand1 |= tmp >> 1;
  operand2 = ((uint32)REG_Y_R_CURRENT() & 1) ? {REG_OR_IMM_RSVD} : 0;
  result = (uint64)operand1 + (uint64)operand2;
  REG_Y_W_CURRENT((uint64)(((tmp & 1) << 31) | (REG_Y_R_CURRENT() >>
  1)));
  new_cc.b.icc_n = (result >> 31) & 1;
  new_cc.b.icc_z = ((uint32)result == 0);
  new_cc.b.icc_v = ((int32)((operand1 \hat{ }˜operand2) & (operand1 \hat{ }(uint32)result)) < 0);
  new_cc.b.icc_c = ((uint32)result < operand1 ∥ (uint32)result < operand2);
  new_cc.b.xcc_n = 0; /* can never be negative */
  new_cc.b.xcc_z = (result == 0);
  new_cc.b.xcc_v = 0; /* can never overflow */
  new_cc.b.xcc_c = 0; /* can never generate carry */
  SET({DST}, result);
  set_cc_current(new_cc);
  #}
attributes
NOT_HANDLED_BY_TURBO
```

If it is later decided that MULSCC is important enough for code generation, we would remove the NOT_HANDLED_BY_TURBO attribute and implement the target-specific macros needed for this operation.

Each Turbo1 operation maps to a sequence of host assembly instructions. By way of example, exemplary code is shown below for the x86 host description for a 64-bit add operation:

Add(i64 dest, i64 src1, i64 src2) {
Mov(lo32(dest), lo32(src1))
Mov(hi32(dest), hi32(src1))
Add_RR(lo32(dest), lo32(src2))
Adc_RR(hi32(dest), hi32(src2))
}

When the compile mechanism in the emulation core triggers, the templates for each instruction in the block to be compiled will first be concatenated. After that the parameters for each template are instantiated i.e. provided with actual parameters by using values provided by the instruction decoder. Since this typically provides lots of opportunities for optimizations, such as value propagation and dead code removal, basic optimizations are generally performed on the concatenated template before handing it over to the host code generator.

The host code generator simply matches each operation against the turbo1 operation descriptions, generating a list of host assembly instructions. Following register allocation, that list of instructions is written to memory as a complete function which will replace the function of the normal interpreter service routine when the corresponding block of instructions is to be emulated.

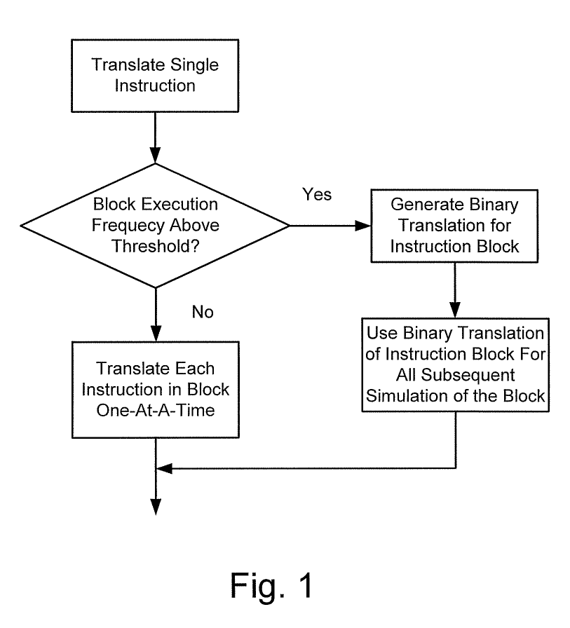

FIG. 1 shows a flowchart of multimode simulation method operating in accordance with an embodiment of the invention. The invention contemplates a multimode simulation approach to reduce the overhead caused by the exclusive use of the simulation technique of one instruction-at-a-time interpretation by additionally using binary translation for executed blocks of interpreted instructions (that contain no jumps out of the block) from the same instruction set architecture description. Since performing translations too frequently can undesirably increase overhead by overloading the cache, it is prudent to perform the binary translation only for blocks that are executed frequently, for example, for those executed more than a threshold value of 4 thousand times. Once the block is translated e.g. by forming the block from instructions via templates and generating the collective code, the overall simulator performance is significantly improved by running the block instead of running the instructions one-at-a-time. It should be noted that the optimal threshold value might vary from the given example and can be determined by heuristics run on the particular set of simulated code.

To achieve commercial quality reliability the binary translation is generated automatically from a plurality of instruction specifications. In the simulated environment the combined use of individual interpretation of instructions and binary translation must yield equivalence in terms of simulated output results regardless of which one is used and how much. A number of pre-generated templates can be used for the instructions whereby a number of different templates can be used for the same instruction in process referred to as specialization. By way of example, different templates can be used for an instruction depending on the register that is being accessed. Generally, the more templates the more efficient the compilation becomes.

The foregoing description of the preferred embodiment of the invention has been presented for purposes of illustration and description. It is not intended to be exhaustive or to limit the invention to the precise forms disclosed, since many modifications or variations thereof are possible in light of the above teaching. Accordingly, it is to be understood that such modifications and variations are believed to fall within the scope of the invention. It is therefore the intention that the following claims not be given a restrictive interpretation but should be viewed to encompass variations and modifications that are derived from the inventive subject matter disclosed.

1. A method of simulating in software a digital computer system that provides improved simulation performance comprising the step of:
performing simulation using a multimode process that includes the steps of:
performing dynamic translation of individual instructions in a one-at-a-time process; and
performing binary translation for suitable blocks of instructions;
wherein the translations are generated from the same instruction set architecture description and, during simulation, the exact same output result is achieved regardless of whether or to what extent the single instruction interpretation or the binary translation process is used.

2. The method according to claim 1 wherein, the binary translation is performed for blocks of instructions that contain no jumps out of block and are executed frequently.

3. The method according to claim 2 wherein, the execution of the binary block code is triggered by a threshold value set by determining an optimal frequency for the simulated execution of the block based on statistics collected during simulation.

4. The method according to claim 1 wherein, the instructions defined by the specification automatically generates the binary translation for the instructions in the block.

5. The method according to claim 1 wherein, the multimode simulation process uses a plurality of preprepared instruction templates to increase the efficiency of the compilation step.

6. The method according to claim 5 wherein, a plurality of specialized templates for each instruction may be used for the binary translation.

7. The method according to claim 1 wherein, the translated code is reused when the simulation returns to execute the code in the same location in memory.

8. A system for simulating in software a digital computer system by using a multimode simulator comprising:
means for dynamic single instruction interpretation; and
binary translation means for translating suitable blocks of instructions from the same instruction set architecture description, wherein during simulation the exact same output result is achieved regardless of whether or to what extent the single instruction interpretation or the binary translation process is used.

9. The system according to claim 8 wherein, the instruction set architecture description comprises means for automatically generating the binary translation.

10. The system according to claim 8 wherein, further comprising means for determining the blocks of instructions that are suitable for binary translation.

11. The system according to claim 8 wherein, further comprising means for automatically generating the binary translation for the instructions from the specification.

12. The system according to claim 8 wherein, further comprising means for generating a plurality of preprepared instruction templates for increasing compiling efficiency of the instructions.

13. The system according to claim 8 wherein, further comprising means for collecting and analyzing statistics for determining an optimal threshold value for the frequency of execution of the instruction block to trigger the use of the binary translation code for the block.

14. A computer program product capable of being run on a host system for simulating in software a digital computer system, comprising:
a computer readable storage medium having a computer readable program code means embedded in said medium, the computer readable program code means comprising:
computer instruction means for performing simulation in software of a digital computer system that provides improved simulation performance by using a multimode simulation process comprising:
computer instruction means for providing dynamic single instruction interpretation; and
computer instruction means for providing binary translation for suitable blocks of instructions from the same instruction set architecture description, wherein during simulation the exact same output result is achieved regardless of whether or to what extent the single instruction interpretation or the binary translation process is used.

15. The computer program product according to claim 14 wherein, the computer readable storage medium containing the computer readable program code is operable to be run independent of the host system's operating system.

16. The computer program product according to claim 14, wherein the computer readable storage medium containing the computer readable program code is operable to simulate a network of virtual digital computer systems running different operating systems.
